(19) United States
(12) Patent Application Publication
(10) Pub. No.: US 2015/0306595 A1
(43) Pub. Date: Oct. 29, 2015

(54) Nanoparticulate Apatite Coated Calcite/Limestone Filter Materials for Removing Contaminants from Contaminated Water

(71) Applicant: The Trustees of Princeton University, Princeton, NJ (US)

(72) Inventors: Satish C. B. Myneni, Princeton, NJ (US); Peter JAFFE, Princeton, NJ (US)

(21) Appl. No.: 14/695,220

(22) Filed: Apr. 24, 2015

Related U.S. Application Data
(60) Provisional application No. 61/984,392, filed on Apr. 25, 2014.

(51) Int. Cl. B01J 41/02; C02F 1/28; B01J 41/10

(52) U.S. Cl. CPC B01J 41/02; B01J 41/10; C02F 1/281; C02F 2101/14

(57) ABSTRACT

The invention provides hydroxyapatite-coated carbonate mineral particulate filter materials, and a novel synthesis process. The filter materials are particularly effective in removing fluoride contaminants from contaminated water and may render the treated water ingestible. Also disclosed are articles containing the hydroxyapatite-coated carbonate mineral particulate filter materials.

This patent application fully incorporates by reference the entirety of U.S. Ser. No. 61/984,392 filed 25 Apr. 2014, as if set forth herein.

The present invention relates to compositions and methods for treating contaminated water.

Elevated levels of fluoride in groundwaters of granitic and basaltic terrains pose a major environmental problem and are affecting millions of people all over the world. Everyday many people, especially in the developing world, are exposed to elevated levels of fluoride, which has been found to be well above the World Health Organization drinking water limits. Fluorosis, a disease caused by chronic excessive ingestion of fluoride (F⁻) primarily through drinking contaminated groundwater, is a major health challenge particularly in developing countries. Around 200 million people across 25 nations are affected by fluorosis, including significant populations in India, China, and eastern Africa, and are exposed to groundwater fluoride levels above 1.5 ppm (79 μM; the drinking water limit set by the World Health Organization (WHO)). The fluoride concentrations in some of these contaminated groundwaters in developing countries are in the range of a few tens of ppm, and a cost-effective fluoride removal method is urgently wanted. When exposed to fluoride, humans lose cognizant skills at low levels, and mental dementia, dental and skeletal fluorosis with increasing concentrations.

Several remediation strategies are currently employed; however, many of them require significant maintenance and are expensive to operate, which limits their practical availability. most of these defluoridation techniques are based on either membrane technologies, such as reverse osmosis, nanofiltration, electro-dialysis; or adsorption methods, which utilize aluminum and calcium based adsorbents (e.g. alumina, hydroxyapatite), and synthetic resins. Several of these technologies have high defluoridation capacities; however, many of these suffer from high operation and maintenance costs, production of secondary pollutants, and complex treatment processes.

While apatite is known in the art to remove fluoride from drinking water, the naturally occurring forms of apatite are relatively inefficient in terms of cost, their sorption capacity and the manner in which they are used.

Thus, there is a real and urgent need to provide new materials, and new processes for the production of such new materials, which are effective in treating contaminated water, particularly for the removal of fluoride from water contaminated therwith. It is to these needs, as well as others, to which the present invention in its various aspects relates.

In one aspect the present invention provides novel hydroxyapatite-coated carbonate mineral particulate filter materials produced according to an novel synthesis process which filter materials are particularly effective in removing fluoride contaminants from drinking water sources or wastewater, which removal may be accomplished at a very low cost, and which does not introduce other contaminants into the treated water.

In a further aspect the present invention provides novel hydroxyapatite-coated carbonate mineral particulate filter materials effective in removing fluoride ions from drinking water sources or wastewater, wherein the hydroxyapatite coating are one or more crystalline forms of hydroxyapatite present on the surface of the carbonate mineral particles.

In a further aspect there is provided a filter medium or filter assembly which comprises novel hydroxyapatite-coated carbonate mineral particulate filter materials as described herein, further in conjunction with at least one further filter material or composition, and/or at least one further article or construction, such as a supporting medium, used in conjunction with the novel hydroxyapatite-coated filter materials.

In a still further aspect there is provided a novel synthesis process for the production of novel hydroxyapatite-coated carbonate mineral comprising particulate filter materials or compositions, and/or at least one further article or construction, such as a supporting medium, used in conjunction with the novel filter materials.

In a still further aspect there are provided methods for the treatment of contaminated water containing fluoride, which method comprises the steps of: contacting contaminated water containing fluoride ions or other fluoride materials with the novel hydroxyapatite-coated carbonate mineral comprising filter materials, and thereby reducing the concentration of said fluoride ions or other fluoride materials in the treated contaminated water, preferable to levels which are considered safe to be ingested, e.g, meeting or exceeding one or more governmental or agency guideline, e.g. WHO guidelines.

These and further aspects of the invention will be better understood from a reading of the following specification, drawing figures and claims.

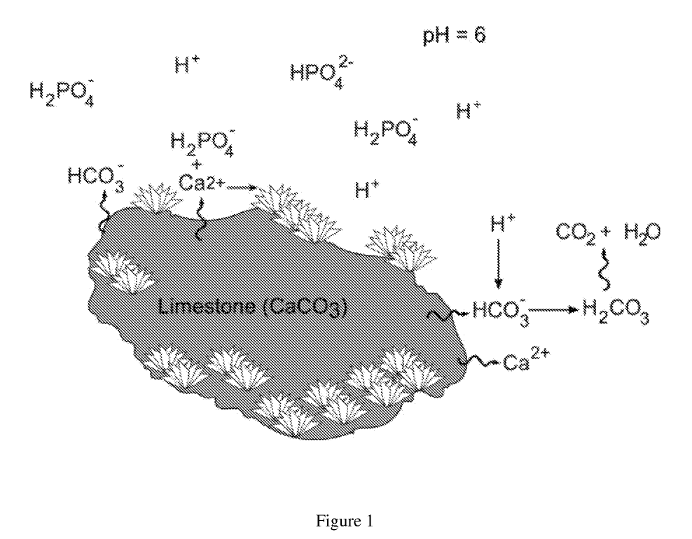

FIG. 1 depicts a conceptual representation of a preferred hydroxyapatite-coated filter material of the invention.

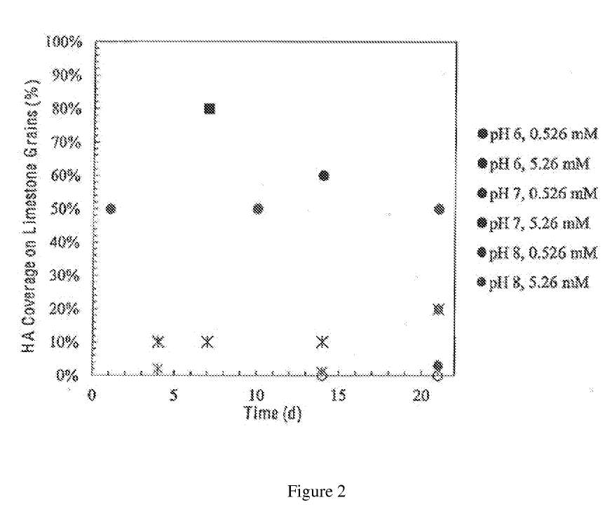

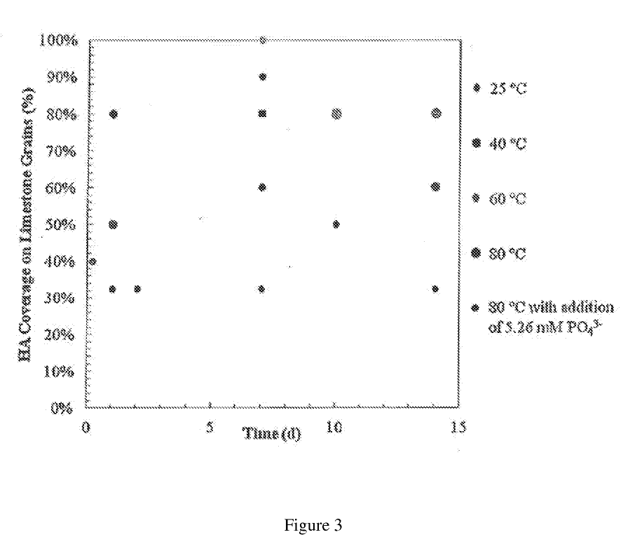

FIGS. 2 and 3 each depict graphical representations of the degree of coverage of limestone particles as a function of specific reaction conditions.

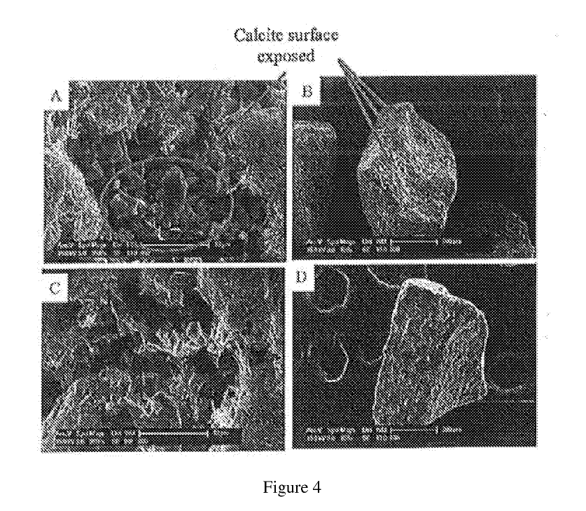

FIG. 4 are photomicrographs of hydroxyapatite coated surface of limestone grains.

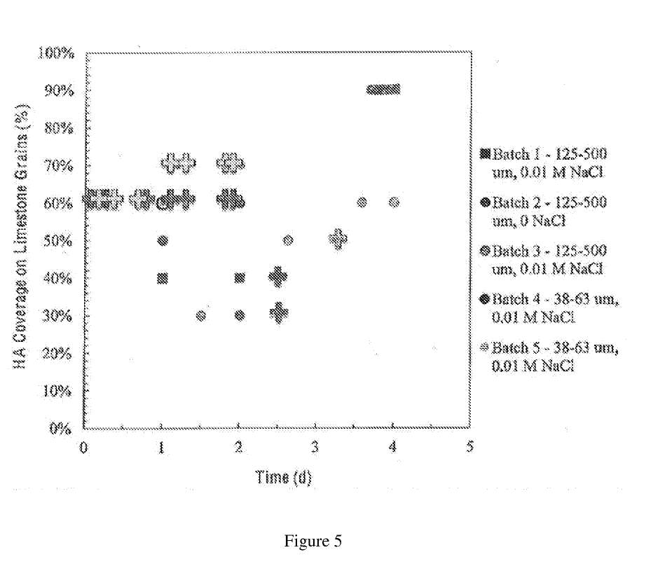

FIG. 5 presents a graphical representation of the degree of coverage of limestone particles as a function of specific reaction conditions.

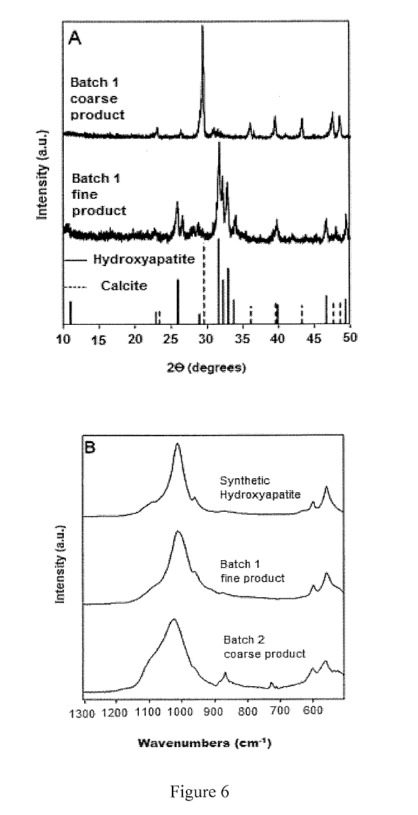

FIG. 6 depicts XRD patterns (“A”) and ATR-FTIR spectra (“B”) of hydroxyapatite coated limestone particles.

FIG. 7 depicts in its four panes or parts representative SEM images of limestone particles (viz., carbonate mineral) showing the progression of surface coverage of hydroxyapatite from 0% to 100% surface coverage.

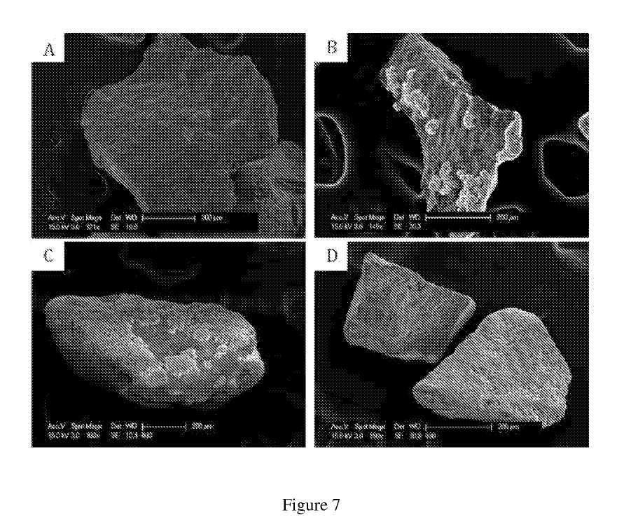

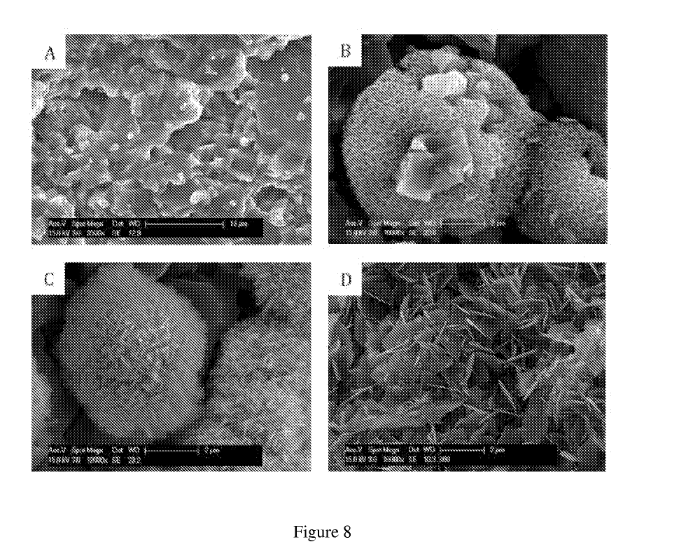

FIG. 8 depicts in its four panes or parts representative SEM images of hydroxyapatite coatings on limestone grains showing the crystal habitats of the hydroxyapatite.

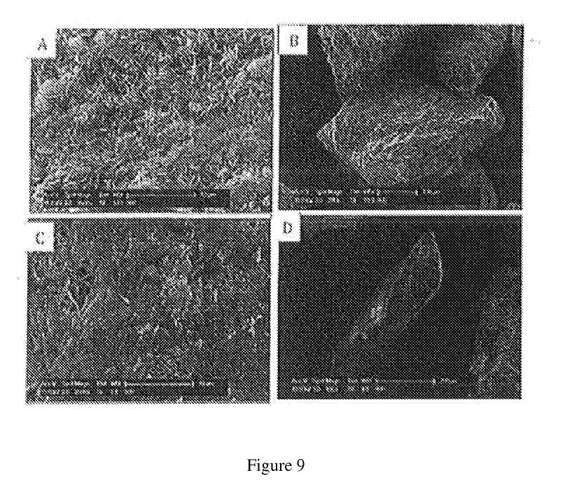

FIG. 9 illustrates hydroxyapatiate coated limestone particles at magnifications of 3500× and 200×.

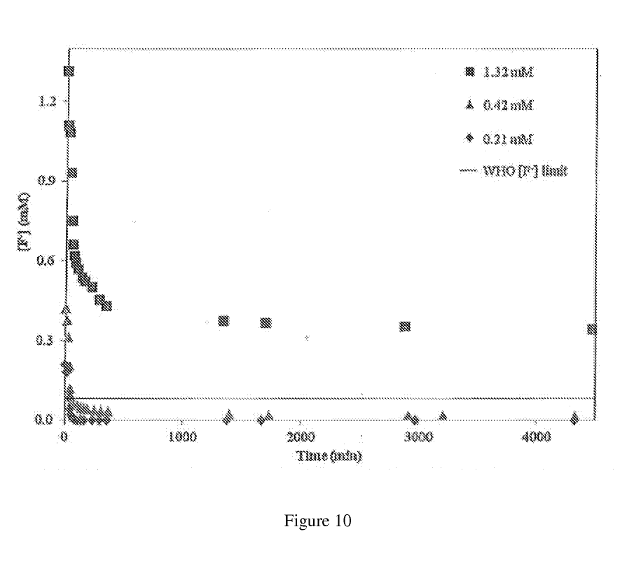

FIG. 10 provides a graph of rate of F⁻ sorption by hydroxyapatite coated limestone.

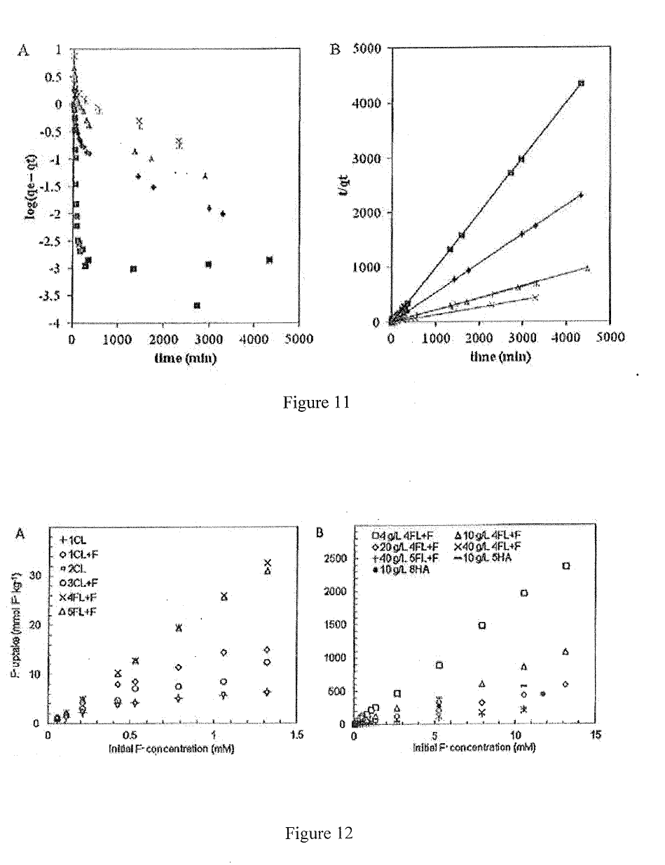

FIG. 11 is a graph of rate of F⁻ sorption by hydroxyapatite coated limestone according to different rate models.

FIG. 12 illustrates fluoride sorption capacity of different synthesis products produced according to the invention.

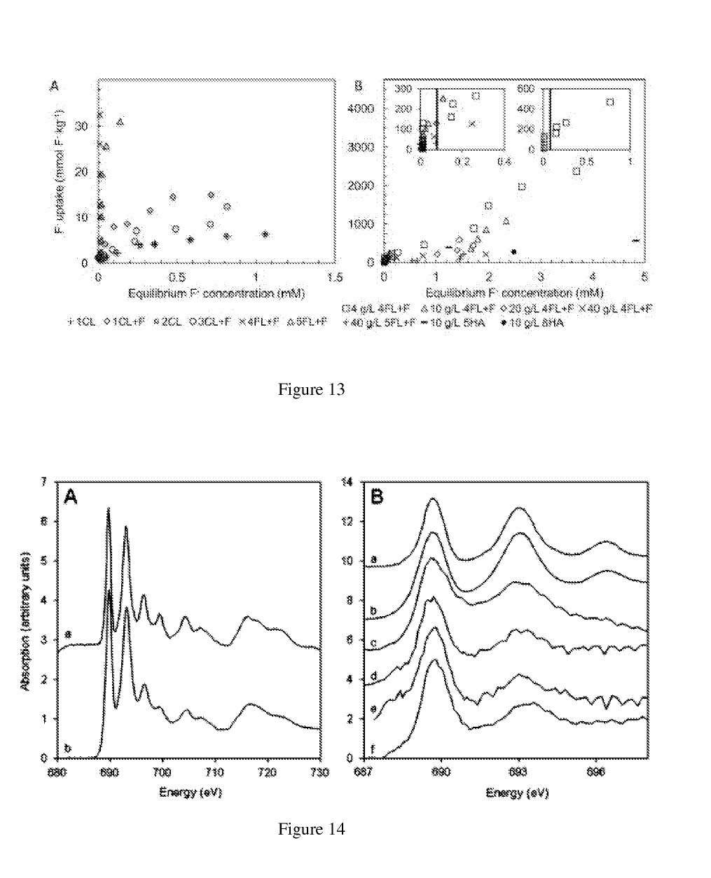

FIG. 13 depicts F⁻ absorption isotherms of different synthesis products produced according to the invention

FIG. 14 illustrates fluorine K-edge XANES spectra of (a) fluorite CaF₇ and hydroxyapatite exposed at various pH and F⁻ concentrations.

Broadly speaking, in one aspect the invention provides nanometer to micrometer sized particulate materials based on carbonate minerals which present on all or part of their surface hydroxyapatite, preferably in a crystal form, which are useful as filter materials.

The carbonate minerals may be of various purities, and may be sourced from limestone, seashells, or other sources and materials which contain calcite or dolomite (all of which hereinafter may be collectively or severally herein referred to as “limestone/calcite” or “carbonate mineral” or “carbonate material”.) As many naturally occurring sources of suitable carbonate material are distributed globally, they are also expected to be readily accessible. Virtually any source of carbonate minerals may be used, and preferred are those having a high content of calcite. Comminution may be undertaken by any suitable processes including but not limited to crushing such as by ball milling, and the resultant comminuted carbonate minerals may be sorted, such as by sieving, into appropriately sized and size distributions of the carbonate material.

Filter materials of the invention are formed by the controlled formation of hydroxyapatite onto granular and preferably micron (and/or submicron) sized carbonate minerals particles, particularly preferably limestone/calcite particles which have a mean particle size in the range of about 0.1 to about 1000 microns (μm), preferably about 10 to about 800 microns, still more preferably about 25 to about 500 microns, and in certain preferred embodiments about 40 to about 300 microns, with particularly preferred particles being disclosed with reference to one or more of the examples. Such particle sizes may be established by separation according to known techniques and using known apparatus or technique, e.g., finely sized screens, centrifuging, or other apparatus or technique. The sized of individual particles may based on their largest dimension, as irregularly shaped particles of carbonate minerals may be and are frequently used. The ultimate selection of mean particle size is dependant upon the ultimate filtration process in which the hydroxyapatite-coated carbonate mineral particulate filter materials are to be used. A uniform and controlled particle size and particle size distribution in the above ranges is preferred particularly to ensure that good fluid transport of contaminated water is provided, and at the same time that an acceptable pressure drop across a filter comprising the hydroxyapatite-coated filter materials particularly when such are used in conjunction with at least one further filter material or composition, and/or at least one further article or construction, such as a supporting medium for the hydroxyapatite-coated filter materials, and any other optional further filter material or composition when present.

The hydroxyapatite-coated filter materials preferably comprise crystalline nano-particles of hydroxyapatite covering at least a part, and while such may be as little as about 1%, is preferably at least about 25%, more preferably between about 50%-100%, still more preferably (and in order of increasing preference, and in %) at least about 55, 60, 65, 70, 75, 80, 85, 90, 92.5, 95, 97.5, 98, 99, 99.5 of the surface of the particles of carbonate minerals upon which they are present. The covering hydroxyapatite-coated filter materials may form a continuous, or non-contiguous coating layer upon the support or substrate of the carbonate mineral.

The hydroxyapatite-coated filter materials may be formed by providing carbonate mineral particles with further constituents into a liquid medium, i.e., water (which may optionally contain up to about 20% w/w of a non-aqueous liquid, such as organic solvent) to which is added, or alternately within which is already present a phosphate, i.e., PO₄³⁻, which is also present in a sufficient concentration such that it is reactive with the surfaces of the carbonate minerals, such that hydroxyapatite (Ca₅(PO₄)₃OH) is formed on the surface of the carbonate mineral particles. Preferably the hydroxyapatite is present on the surface in one or more crystalline forms. While virtually any concentration, amount or proportion of the carbonate mineral particles, phosphate and the liquid medium may be used, advantageously the amount of the carbonate mineral particles per liter of the liquid medium is from about 0.1 to about 1000 grams/liter, more preferably from about 1 to about 200 grams/liter, yet more preferably from about 10 to about 50 grams per liter. The concentration of the phosphate included in the reaction mixture may vary as well, and such may be added as a single amount or as several separate additions (aliquots) of an amount of phosphate during the reaction, until a desired total or cumulative amount of the phosphate is provided. The total amount of phosphate added during the reaction should be sufficient to provide a suitable extent or degree of coating upon the carbonate mineral particles and yet not be in an excess amount such that the quality of treated water is later compromised. The amount of phosphate may be added to provide a concentration, of between about 0.01 mM to about 250 mM in the liquid medium which is reduced as a consequence of the reaction. More preferably the concentration is between about 0.1 to about 100 mM, still more preferably from about 0.5 to about 50 mM, and particularly preferably about 1 to about 25 mM, which may be per liter of the liquid medium. The amount to be added will of course depend upon the size and concentration of the carbonate mineral particles and their size, as well as other process variables such as pH and temperature during the reaction. The total amount of the phosphate during any step of the reaction, or during the entirety of the reaction may also vary. Preferably the inventors have found that good formation of the hydroxyapatite layer upon the carbonate mineral particles occur when there are two or more, separate additions of phosphate during the total reaction time. It was also found that several additions of phosphate, i.e, two or more, preferably at least 3 or more separate additions, lead to almost complete coatings or coverage without excess phosphate.

Concurrently, during the reaction, the pH is preferably maintained in the range of about 3 to about 11, more preferably in the range of about 5 to about 9, and especially preferably in the range of about 6 to about 8.5. Such may be maintained by the addition of a suitable acid, such as an organic acid or inorganic acid, (i.e., HCl) and/or by the addition of a suitable caustic or base, such as an inorganic base (i.e, NaOH). A pH buffer material may also be included in effective amounts in order to maintain the pH of the reaction mixture within a desired pH range. The pH level is also in part influenced by the temperature of the reactants and the liquid medium, with higher temperatures being preferred. Preferably the reaction forming the hydroxyapatite-coated filter materials occurs at a temperature in the range of about 5° C. to about 99° C., more preferably is in the range of about 15° C. to about 95° C.; a particularly preferred reaction temperatures is in the range of about 75° C. to about 90° C., and most preferably from about 80° C. to about 90° C.

The reaction may be a batch type reaction, or a continuous reaction but good control of the reaction is attained with a batch type reaction. Preferably the reactants and the liquid medium are stirred during all or part of the reaction, but stirring is not essential but is preferred to ensure that the water insoluble carbonate particles are suspended in the liquid medium during at least part of the reaction.

Under the foregoing conditions, while the reaction time may be as short as about 1 minute, preferably at least about 1 hour, advantageously longer reaction times are preferred as such permits for a greater amount of hydroxyapatite to be formed on the particulate carbonate materials. Furthermore the reaction conditions, e.g, pH, temperature and whether the contents of a reaction vessel (or tank) are stirred for all or part of the reaction also play a role on the amount of hydroxyapatite formed on the carbonate materials. Advantageously, reaction times are from between about 24 hours to about 480 hours provide good results, and preferably reaction times from about 80 hours to about 240 hours are used. Particularly preferred concentrations, and reaction conditions are disclosed with reference to one or more the following examples.

Subsequent to the reaction between the carbonate mineral, and the phosphate under the foregoing conditions, the solids fraction of the reaction mixture, which comprises or consists essentially of the hydroxyapatite-coated filter materials may be separated form the liquid medium by any suitable technique such as by centrifuging, or filtration through a filter medium such as filter paper or through a filter pack. The formed hydroxyapatite-coated filter materials are preferably dried before use in treating water known to be or suspected of being contaminated with an excess of fluoride. The preferred form of the resultant reaction product is an dry, free flowing granular or pulvurent hydroxyapatite-coated filter material which may used by itself to treat water, or form part of a filtration apparatus and used in continuous or batch process for the treatment of contaminated water containing or suspected to contain fluoride.

FIG. 1 illustrates a conceptual representation of a preferred hydroxyapatite-coated filter material of the invention being formed by the in-situ formation of hydroxyapatite crystals directly on the surface of the limestone particle (carbonate mineral) from the surrounding reaction medium containing water, and a phosphate which provides a source of phosphate ions.

In certain particularly preferred embodiments the hydroxyapatite-coated carbonate mineral comprising particulate filter materials of the have an overall dimension 0.1 to about 1000 microns (μm), in certain preferred embodiments the novel particulate filter materials of the invention are about 40 to about 300 microns in their largest dimension.

The hydroxyapatite-coated carbonate mineral comprising particulate filter materials of the invention are highly reactive due to their high surface area and the degree or amount of hydroxyapatite present on their surface.

It has been observed that concurrent with the foregoing hydroxyapatite formation reaction, there is also a competing reaction wherein chloroapatite (Ca₅(PO₄)₃Cl) may be formed concurrently with hydroxyapatite (Ca₅(PO₄)₃OH). This can be controlled by limiting the pH of the liquid medium in the reactants which it contains as well as the reaction temperature such that the more rapid precipitation of the smaller, high surface area hydroxyapatite crystals is caused to occur. Such reaction kinetics can be influenced by reducing the pH to during the reaction to be in the range of about 4.5-6.0, which encourages the dissolution of calcite of the carbonate materials, to thereby supply more available calcium ions (Ca²⁺) without undesirably destabilizing the hydroxyapatite in the presence of the PO₄³⁻. Such preferred reaction kinetics can also be influenced by preferably concurrently also maintaining the temperature of the reaction in the preferred ranges previously described. Again, particularly preferred concentrations, and reaction conditions are disclosed with reference to one or more the following examples.

When the resultant hydroxyapatite-coated filter materials are contacted with water containing fluoride ions (F⁻) the hydroxyapatite Ca₅(PO₄)³OH undergoes an ion-exchange reaction therewith to form either fluorapatite (Ca₅(PO₄)³F), or a mixed fluoridated-hydroxyapatite (Ca₅(PO₄)₃OH,F)), the latter two species which are more thermodynamically stable than the the hydroxyapatite Ca₅(PO₄)³OH. This reaction is rapid and removes the fluoride ions (F⁻) from the water, i.e, contaminated water, wastewater, and the like. The inventors had found that when the exposed to water containing fluoride, the synthetic hydroxyapatite (and/or chloroapatite) phases present upon the carbonate mineral substrates react with aqueous fluoride and convert to more insoluble fluorapatite at low fluoride concentration, and tofluorite (CaF₂) at higher concentrations. The rate at which fluoride is adsorbed by the novel hydroxyapatite-coated filter materials was observed to be both rapid, and provided a high removal efficiency of the fluoride ions in the treated water.

The novel hydroxyapatite-coated filter materials taught herein may be used to treat water contaminated with our suspected of being contaminated with fluoride materials, i.e, fluoride at virtually any temperature as long as the water being treated remains fluid. Liquid water may be effectively treated, at any temperature but ambient temperature conditions of between about 10° C. to about 30° C., preferably about 15° C. to about 25° C. and particularly preferably at about mom temperature, i.e., 20° C.-22° C. are effectively treated. The pH of the water may be also acidic, neutral or basic, and preferably the water being treated is in the range of about pH 5 to about pH 9. Contact time between the novel hydroxyapatite-coated filter materials and the water being also depends upon the concentration of the undesired fluoride ions present, the concentration of the hydroxyapatite-coated filter materials, the method of contact, and other parameters including temperature. While contact time may be as long as several (2 or more days) usually contact times may be shorter, i.e, from as little as 30 seconds, preferably at least about 1 minute to about 12 hours, preferably to about 6 hours, more preferably to about 4 or 5 hours. It is to be understood that with regard to time, it is required that that such time be sufficient to remove or sorb the fluoride ions to a sufficient extent to reach safe ingestion, i.e., drinking levels.

It has been found that water treated with the novel hydroxyapatite-coated filter materials do not have off-tastes which are attributable to the novel hydroxyapatite-coated filter materials, or are in any way discolored due to contact with the novel hydroxyapatite-coated filter materials.

The novel hydroxyapatite-coated filter materials are also effective in swiftly removing fluoride ions from water, i.e., contaminated water, usually to concentrations of fluoride ions at or below detection levels upon contact with the hydroxyapatite-coated filter materials provided herein. Preferably such levels meet the safe threshold standards of one or more governmental, administrative or scientific agencies or regulatory organizations, i.e, U.S. EPA, World Health Organization, or others.

As briefly noted previously the hydroxyapatite-coated carbonate mineral comprising particulate filter material may used by itself, or form part of a filtration apparatus and used in continuous or batch process for the treatment of contaminated water containing or suspected to contain fluoride ions from water, i.e, contaminated water or wastewater. The hydroxyapatite-coated carbonate mineral comprising particulate filter material may be used in the treatment of aqueous compositions particularly where the presence of fluoride is known to exist, or suspected to be present. Such aqueous compositions can be static compositions, such as a volume contained within a suitable container such as a tank, cistern, pool, or other holding vessel, or such aqueous compositions may be a moving stream of an aqueous composition, such as a volume of aqueous composition passing through a fluid conduit, i.e, pipe, tube, fluid stream, channel, and the like. Filter material of the invention can be used in any water treatment process which can be operated as a batch process, a continuous process, or process which includes portions which are operated as batch processes and portions which operated as continuous processes. Indeed, the filter material according to the invention can be readily incorporated into any known art water treatment process. The filter material of the invention can be utilized to treat any volume of water and is not limited to necessarily industrial processes can be used in domestic processes and apparatus of relatively smaller scale as well. For example, an apparatus comprising a filter cartridge or filter bag containing a quantity of the filter material of the invention is used in conjunction with an apparatus such as a drinking vessel, a treatment jug, transport vessel, or holding tank which contains a quantity of water to be treated prior to ingestion. The filter material (as may be contained within a filter cartridge, filter bag or filter pack) may be immersed within or otherwise contacted with the quantity of water and the interaction of the hydroxyapatite present may react directly with fluoride present in the quantity of water. The inventors have surprisingly found that the hydroxyapatite-coated carbonate mineral comprising particulate filter material are particularly rapid in the reaction with ions and thus very effective reduction in the levels of such undesired materials may be effectuated. Alternatively, or in conjunction therewith, such an apparatus i.e, a drinking vessel, a treatment jug, transport vessel, or holding tank is configured such that water contained within only comes into contact with the hydroxyapatite-coated carbonate mineral comprising particulate filter material as it is being withdrawn, removed from within said apparatus. Such again may be conveniently realized by providing the filter material such that the water being withdrawn a removed comes into contact at that time but prior to ingestion. Again, for the sake of convenience a quantity of the filter material may be provided as part of or contained within a filter cartridge, filter bag or filter pack. It is only required that the relatively short contact time be provided between the water, and the filter material in order to provide an effective reduction of the undesired fluoride present in the quantity of water be allowed to occur prior to ingestion. In a particularly simple, low-cost embodiment a quantity of the filter material is provided within the confines of a porous container, such as a bag formed of a woven or nonwoven material, paper, mesh, screen, or any other membrane, textiles, fabrics which allows for the transfer of water containing or suspected to contain undesired levels of fluoride, present in the quantity of water and subsequently come and contact with the filter material. Such can be as simple as a “tea bag” type article which permits for contact, freshly immersion of the filter material within the quantity of water. Again, the observed rapid reaction between the hydroxyapatite with the undesired fluoride present provides a high degree of reduction of such undesired materials and does not require a complex, nor expensive device. It is also contemplated that water containing, or suspected to contain an undesired level of fluoride present in the quantity of water may be treated by merely providing a holding tank, or other vessel into which said water is provided, the holding tank or other vessel having contained therein, such as in the form of a sediment, or layer, or coating, an effective amount of the hydroxyapatite-coated carbonate mineral comprising particulate filter material. Where the dimensions of such a holding tank or vessel are sufficiently large such that the amount of the layer of the hydroxyapatite-coated carbonate mineral comprising particulate filter material present is essentially static, no further downstream filtration is required yet effective treatment of the water can be achieved. Of course, treated water exiting such a holding tank or vessel may also passed through downstream particulate filter is meant to capture and entrain any of the hydroxyapatite-coated carbonate mineral comprising particulate filter material which might exit.

The hydroxyapatite-coated carbonate mineral comprising particulate filter material may be used in conjunction with other known materials effective in providing a treatment benefits to water. Such includes for example activated charcoal or carbon which is frequently used to improve the taste of potable water, or an oxidizing agent which may be used to provide an antimicrobial effect and reduce the level of pathogens known to, or suspected to also be present within water being treated.

The hydroxyapatite-coated carbonate mineral comprising particulate filter material may be used with virtually all other known materials and articles useful in water treatment applications, for example as part of a filter assembly which contains one or more materials or articles which are used to trap particulate materials based on their particle size. For example such include porous cellulosic, polymeric, as well as non-polymeric filters media. Such may be screens, or paper filters combinations thereof. The hydroxyapatite-coated carbonate mineral comprising particulate filter material may be incorporated directly into the filter media, or be present upon the filter media. The former might for example be achieved by an amount of the hydroxyapatite-coated carbonate mineral comprising particulate filter material in the fibers or pulp used to form a paper or cellulosic filter. Alternately, a quantity of the hydroxyapatite-coated carbonate mineral comprising particulate filter material may be included within, and amongst the polymer materials used form filter media. In such a manner, the hydroxyapatite-coated carbonate mineral comprising particulate filter material is immobilized and forms a part of the construction of the filter medium. In a further alternative, quantity of the hydroxyapatite-coated carbonate mineral comprising particulate filter material may be used as an additive or constituent which is added the further constituents necessarily to form a foam composition there from. Such for example may be expanded open or closed cell polymeric foams. Alternately, such may be foams (or sponges) formed from regenerated cellulose. All the foregoing, advantages of incorporation of the quantity of the hydroxyapatite-coated carbonate mineral comprising particulate filter material during the production of the filter media itself permits for the containment and immobilization of the said filter material which is in particulate form. Such a filter media also acts as a physical support structure as well.

In a further alternative, wherein filter media is formed of a multilayer, laminate construction, and is also conceived that quantity of the hydroxyapatite-coated carbonate mineral comprising particulate filter material may be present within two, or more of the layers which optionally, but preferably can be sealed about the periphery of the said layers thereby trapping or encasing the particulate filter material within. Again such acts as a physical support structure and concurrently acts to contain and immobilize the hydroxyapatite-coated carbonate mineral comprising particulate filter material.

The following examples demonstrate certain aspects of the invention.

### EXAMPLES E1-E6

Hydroxyapatite-coated carbonate mineral comprising particulate filter materials were produced and their efficacy in removing or reducing fluoride ions is disclosed in the following.

Stock Solutions—

All solutions, viz, stock solutions, were prepared with ultrapure (deionized) water obtained from a Millipore Q-Gard 2 system (18.2 MΩ). Solutions were prepared using sodium dihydrogen phosphate (MP Biomedicals, Inc.) and sodium chloride (EMD Chemicals, Inc.). All F⁻ solutions were prepared from a 1000 ppm (52.63 mM) Sigma-Aldrich NaF stock solution.

Synthesis of Hydroxyapatite-Coated-Calcite—

A sample of optically pure Iceland spar (CaCO₃) was, broken into pieces of 0.5-2.0 mm, and washed for 30 minutes in 0.01 M HCl to remove surface contaminants. The crystals (solid to solution ratio of 20 g L⁻¹) were reacted with NaH₂PO₄ (herein referred to as PO₄³⁻) solutions (0.526 or 5.26 mM P) at a pH of 6.0±0.1 at 25° C., and in 0.01 M NaCl background electrolyte. The pH of the samples drifted to 8.4, and the pH was adjusted close to 6 once a day using HCl (and a minor amount of NaOH if necessary). A few (about 2-4) crystals from each batch were removed at intervals of 1, 2, and 6 days and washed prior to later analysis by use of a scanning electron microscopy (SEM).

Synthesis of Hydroxyapatite-Coated-Limestone Particles—

Natural gray limestone, used as the carbonate mineral, was reacted a various pH (6, 7, and 8), temperature (25, 40, 60, and 80° C.) and aqueous PO₄³⁻ concentrations (0.526 and 5.26 mM). During such reactions, the solid to solution ratio was kept constant at 25 g L⁻¹ and 125-500 μm grain sizes were used. A small amount of reacted limestone was collected from each batch at various time intervals up to 3 weeks, filtered and washed with deionized water, and air-dried for microscopic analysis. Initial experiments conducted at 80° C., pH 6, and 5.26 mM PO₄³⁻ resulted in the best coverage of hydroxyapatite crystals on limestone. The results are graphically illustrated on FIGS. 2 and 3. In FIG. 2, the hydroxyapatite coverage on limestone grains is illustrated as a function of the reaction time, PO₄³⁻ concentration, and the pH for the preliminary synthesis (125-500 μm, 40° C., 0.1 M NaCl). FIG. 2 also provides an indication of the crystal morphology attained: “stars” (*) representing fibrous crystals; “filled in circles” representing a mixture of fibrous-platy crystal morphologies, “filled in squares” representing platy crystal morphology. Finally ‘circles’ indicated where hydroxyapatite growth was not observed. In FIG. 3, thereon is indicated the hydroxyapatite coverage on the limestone grains as a function of reaction time and temperature for the preliminary synthesis (125-500 μm, 40° C., 0.1 M NaCl). Similarly the markers provide an indication of the crystal morphology: “circles” representing a mixture of fibrous-platy crystals; “squares” representing platy crystals. Such conditions provided the basis for synthesis of larger batches of hydroxyapatite-coated-limestone for F⁻ sorption experiments.

Six batches (respectively, experimental samples E1, E2, E3, E4, E5 and E6) of hydroxyapatite-coated-limestone were synthesized at 80° C. using a 25 g L⁻¹ solid to solution ratio with an initial PO₄³⁻ concentration of 5.26 mM at pH 6, in an aqueous reaction medium with further characteristics (i.e., particle size, reaction times being reported on Table 1. Batches 1, 2, 3, 4, 5 and 6 correspond to E1, E2, E3, E4, E5 and E6. Batches 1, 2, 3 and 4 corresponding to respective “sample names” 1CL, 1CL+F, 2CL, 3CL+F were produced using 125-500 μm size fraction of limestone and a reaction time of four days, the batches 5 and 6 corresponding to respective “sample names” 4FL+F, 5FL+F were prepared with a 38-63 μm limestone size fraction and a reaction time of two days. Batches 1 and 3, in their final compositions comprised hydroxyapatite-coated-limestone particles without fines, while the remaining batches further included an amount of fines along with the hydroxyapatite-coated-limestone particles.

TABLE 1

| Starting | Sample | Size fraction | Aqueous | Reaction | #. Phosphate | Percent surface | |
|---|---|---|---|---|---|---|---|
| material | name | (μm) | NaCl (M) | time (days) | additions* | coverage | Final composition |
| Coarse | 1CL | 125-500 | 0.01 | 4 | 1 | 90 | HA-coated-coarse limestone |
| limestone | 1CL + F | 125-500 | 0.01 | 4 | 1 | 90 | HA-coated-coarse limestone + fines |
| | 2CL | 125-500 | 0.0 | 4 | 1 | 90 | HA-coated-coarse limestone |
| | 3CL + F | 125-500 | 0.01 | 4 | 1 | 60 | HA-coated-coarse limestone + fines |
| Fine | 4FL + F | 38-63 | 0.01 | 2 | 7 | 60 | HA-coated-fine limestone + fines |
| limestone | 5FL + F | 38-63 | 0.01 | 2 | 7 | 70 | HA-coated-fine limestone + fines |

*PO₄³⁻ concentration for each addition = 5.26 mM

During synthesis PO₄³⁻ was added incrementally to maximize the surface coverage. Batches 1-3 were prepared with one PO₄³⁻ addition, and batches 4-5 with multiple additions of PO₄³⁻; the sequence of these additions and other relevant conditions are represented on FIGS. 4 and 5. In FIG. 4, are illustrated scanning electron microscope images showing the effect of multiple PO₄³⁻ additions on hydroxyapatite surface of limestone grains, wherein “A” and “B” illustrate the effect of the reaction was performed at 80° C., pH 6, 5.26 mM PO₄³⁻ and 0.01 M NaCl for a total reaction number 14 days, and wherein “C” and “D” illustrate the effect to the reaction as performed under the same condition as with reference to “A” and “B”, but addition thereto was also provided a further addition of 5.26 mM PO₄³⁻ at 7 days at the initiation of the reaction. The views of “A” and “C” are at a magnification of 3500×, and the views of “B” and “D” are of the same particles but at a correspondingly lower magnification of only 120×. FIG. 5 illustrates the degree of hydroxyapatite coated surface of limestone grains is a function of the reaction time, the size of the limestone fraction, and the NaCl concentration for this larger-batch scale synthesis, under reaction conditions of 80° C., and 5.26 mM PO₄³⁻. The “plus signs” are indicative of times at which additions of 5.26 mM PO₄³⁻ were made, which were made by removing the limestone grains and placing them into new solutions for batches 1, 2 and 3, and 5.26 mM PO₄³⁻. For batches 4 and 5, additions are made by adding concentrated 263 mM PO₄³⁻ aqueous solution directly to reactions. Also the shape of the marker indicates the type of observed hydroxyapatite crystal morphology: “circles” representing a mixture of fibrous-platy crystals, and “squares” indicative of platy crystals. The reactions were stopped after 2 days for batches 4-5 because multiple additions of PO₄³⁻ produced good coverage (from SEM images) of hydroxyapatite on limestone. During the syntheses, the pH of each solution was adjusted with HNO₃ and NaOH three to four times per day after any PO₄³⁻ addition (for batches 4 and 5, the PO₄³⁻ addition usually lowered the pH to approximately 6.3) to maintain the solutions at pH 6.0±0.1 that might could otherwise drift as high as pH 8.0 for batches 1-3 and 6.8 for batches 4-5. Once the limestone grains were found to be mostly coated, i.e, as could be determined by evaluating a random limestone grain from the reaction mixture using a SEM, the reacted limestone grains were removed from solution, rinsed with deionized water, and air dried. This rinsing procedure varied with batches 1 and 2 experiencing a more rigorous rinsing procedure that smoothed the hydroxyapatite surfaces and batches 3, 4, and 5 experiencing a gentler procedure that did not alter the morphology of the hydroxyapatite crystals, as can be seen from FIG. 5. As is seen from that figure, several SEM images of the batch 1 reaction products are shown, with images “A” and “B” respectively being at magnifications of 3500× and 200× following a reaction time of four days, before washing, and with images “C” and “D” respectively being at magnifications of 3500× and 150× following a reaction time of 4.25 days and subsequent to washing. All of the foregoing batches produced colloidal material rich in hydroxyapatite (10-20 vol. %), and these colloids (or fines) were separated by filtering the supernatant for batches 1-3. Experiments were conducted to evaluate the F⁻ sorption by hydroxyapatite-coated coarse limestone particles alone (batches 1CL and 2CL) and the absorption of fines mixed with hydroxyapatite-coated coarse limestone particles (batches 1CL+F and 3CL+F). However colloids were not separated for batches 4-5 (F⁻ sorption was conducted for the mix of HA-coated-fine limestone and newly formed fines (batches 4FL+F and 5FL+F)).

Hydroxyapatite-coated-limestone grains, viz, examples of the novel filter materials of the invention which were formed as described above were or may be characterized using one or more of the following apparatus and/or techniques.

SEM.

The hydroxyapatite surface coverage and crystal morphology on reacted calcite or limestone was studied using SEM (FEI/Philips XL30 FEG SEM). The reacted samples were sputtered (VCR IBS/TM250 Ion Beam Sputterer) with a 35-64 Å Ir or Au coating. For each sample, the percent coverage of 25-40 individual limestone grains was visually observed and estimated to the nearest 10% and then averaged to determine the percent coverage for a sample.

FTIR.

The limestone and the newly formed coatings were analyzed using attenuated total reflectance Fourier transform infrared spectroscopy (ATR-FTIR, Brukcr IFS 66v/S). Two thousand scans were collected for each sample using a broad band mercury cadmium telluride detector, an aperture setting of 5 mm, and a diamond ATR crystal. Air was used as background to remove the spectral contributions of the ATR crystal and focusing optics. Unreacted limestone was scanned and its spectrum was subtracted from those of the coated samples in order to better differentiate the spectral contributions of the hydroxyapatite coatings from the bulk solid. For spectral comparison, a synthetic hydroxyapatite (ex. Sigma Aldrich) spectrum was also collected. All spectra were compared to published spectra of various apatites and calcite.

XRD.

Structural characterization of the newly formed phases was carried out using grazing incidence X-ray diffraction. The data were collected on a Bruker D8 Discover X-ray diffractometer using Cu—Ka radiation using a power source of 40 mA and 40 kV and was calibrated with Si(111). Scans were collected in the 20 range of 10° to 45° with a step size of 0.01° and a scan speed of 0.5 seconds per step. The collected powder patterns were compared to mineral diffraction powder patterns of limestone and various calcium phosphates.

F K-edge XANES.

F K-edge X-ray absorption near-edge structure (XANES) spectroscopy studies were conducted using Soft X-ray Endstation for Environmental Research (SXEER) endstation, and beamline 11.0.2 at the Advanced Light Source (Lawrence Berkeley National Laboratory). The samples were maintained in 1 atm He, while the rest of the SXEER endstation was kept under high vacuum conditions. The spectra were collected from 680 eV to 730 eV using a high-energy grating, with a step size of 0.1 eV at the absorption edge and 0.4 eV in the pre and post-edge regions. The XANES spectra were collected for fluorite (CaF₂) standard and for F-reacted-HA samples (exposed to varying concentrations (5.3, 11, and 53 mM) at pH 5.5 or 8.0). All spectra were aligned with respect to the 4al peak of F⁻ in fluorite. Data processing was conducted using WinXAS.

Fluoride Sorption Experiments.

Different synthesized batches with limestone grains but devoid of finely precipitated hydroxyapatite (1CL and 2CL), and batches with limestone grains consisting of finely precipitated hydroxyapatite (1CL+F, 3CL+F, 4FL+F, 5FL+F) were used for the F⁻ sorption experiments (Table 1). The synthesized hydroxyapatite-coated-limestone particles were reacted for 3 days with variable F⁻ concentration (0.05-13.2 mM) (solid to solution ratio: 40 g L⁻¹) and mixed gently on a rotating shaker (Glas-Col Culture Rotator Orbital Mixer Shaker at 10 rpm). An additional set of reactions were conducted with batch 4FL+F with variable solid to solution ratios (4, 10, 20 and 40 g L⁻¹). The pH of each of the samples (1CL+F, 3CL+F, 4FL+F, 5FL+F) was adjusted down to 7±0.7 using HNO₃ and NaOH, twice a day, to simulate drinking water pH levels and maximize F⁻ uptake. At the end of the sorption experiments, the supernatant was decanted and prepared for analysis. These results were compared to previous sorption experiments of F⁻ on micron-sized hydroxyapatite (50 m² g⁻¹, average particle diameter 18 μm³⁷) at solid to solution ratios of 10 g L⁻¹ and pH 5 and 8.

Fluoride Sorption Kinetics.

Fluoride sorption by HA-coated-limestone grains was carried out using synthesis batch 4FL+F as a function of concentration—0.21, 0.42, and 1.32 mM—for days at a fixed suspension concentration (4 g L⁻¹). Fluoride concentrations were monitored at different time intervals (10 min initially and less often as the reaction progressed and approached equilibrium) using an Orion 525A meter with a Cole-Panner combination F⁻ ion selective electrode (ISE) with a detection limit of 10⁻⁶ M. The electrode requires the solution pH to be in the range of 5-8; therefore, 50 μL, aliquots of 1 M HNO₃ were added when necessary to maintain a functional electrode pH range. Additionally, this pH range was necessary for F⁻ sorption studies, All samples required the addition of acid with the exception of one of the 0.21 mM solutions, which stayed within the desired pH range for the duration of the experiment. In order to maintain a constant solid to solution ratio in the reaction kinetic measurements and for rapid F⁻ detection, F⁻ measurements were made by directly inserting the electrode into the sample while gently stirring the solutions. When the solutions were not being measured, they were mixed gently on a rotating shaker. Fluoride calibration curves were generated during each continuous session of data collection, with an additional calibration if the session was longer than 3 hours.

Aqueous Phase Analysis.

Aqueous phase analysis of different ions was conducted using either an ion selective electrode (for F⁻), or an inductively coupled plasma (ICP) spectrometer (for Ca, P). An Orion 525A meter with a Cole-Parmer combination F⁻ ion selective electrode with a detection limit of 10⁻⁶ M was used for concentration estimates. This ISE requires the sample solution pH to be in the range of 5-8. Samples were prepared for analysis by acidifying after filtering solids to maintain a pH of 5-8 and by adding a 10% standard ionic strength adjuster (TISAB I). Calibration curves using a range of F⁻ standards were generated before and after each set of experimental measurements. During each measurement, the electrode was left in solution for about 3 minutes with continuous stirring to acquire a stable reading; when readings tended to fluctuate at low F⁻ concentrations, an average millivolt value was recorded. Total Ca and P concentrations were measured with a Perkin Elmer Optima 4300 DV Inductively Coupled Plasma Optical Emission Spectrometer (ICP-OES) using 315.89 nm and 214.91 nm emission lines, respectively. Samples were filtered using a Millipore glass filtration system with 0.4 μm, 25 mm, polycarbonate filter paper and acidified so that the final samples were in 2% nitric acid.

From one or more of the foregoing, was proven (as well as may be proven) the precipitation of nano-microcrystalline hydroxyapatite on carbonate mineral particles, and that such is possible at low concentrations of PO₄³⁻ at room temperature. From one or more of the foregoing, and from these studies on calcite, different syntheses were conducted to optimize conditions for HA growth on granular limestone. The HA coatings grown on granular limestone were characterized for their size, shape, and crystal structure using SEM, FTIR and XRD, and their F⁻ uptake capacities were also determined. In addition, F-XANES spectroscopy was used to evaluate the mechanism of F⁻ uptake by HA. It was generally observed that mineral coatings formed on the surfaces of calcite and limestone when submerged in dilute PO₄³⁻ solutions under the recited reaction conditions. The surface coverage and morphologies of the mineral coatings were dependent on the reaction conditions: nano-scale fibrous coatings sparsely covering the mineral surface at short reaction times, and micron-sized platy morphologies mostly covering the mineral surface at longer reaction times.

Characterization of Phosphate Mineral Coatings on Calcite and Limestone.

The XRD and FTIR studies of the newly formed mineral coatings suggested that they are composed of HA, as can be understood from FIG. 6, which depicts XRD patterns (“A”) and ATR-FTIR spectra (“B”) of hydroxyapatite coated limestone particles. As seen from A, there are depicted the XRD patterns of standard calcite and hydroxyapatite (as a vertical line) for comparison. As is seen from B, the ATR-FTIR spectra of a synthetic hydroxyapatite standard, and the fine and coarse hydroxyapatite coated limestone particles produced from batch 1CL+F exhibit the characteristic v3 and v4 phosphate vibrations in the 1100-1000 cm⁻¹ and 600-500 cm⁻¹ regions. More specifically the XRD patterns of the synthetic phosphate coatings on granular calcite/limestone were identified as hydroxyapatite and not chloroapatate CA (FIG. 6, A). The primary region for the identification of the mineral form of apatite is 30.5-34.5° 20. Chloroapatate has peaks at 31.35° (211), 32.2° (300), 32.3° (112), and 34.1° (202) whereas hydroxyapatite HA has peaks at 31.8° (211), 32.2° (112), 32.9° (300), and 34.1° (202) 20.³⁸ When compared to these standards, the XRD pattern of the fine grained filter material (4FL+F, 5FL+F) exhibited features at 31.7°, 32.2°, 32.9°, and 34.0° 20 indicating the presence of apatite, likely hydroxyapatite with traces of calcite. The coarser filter material (1CL, 1CL+F, 2CL, 2CL+F, 3CL+F) was composed largely of calcite with traces of hydroxyapatite. Other calcium phosphate phases such as mono-, di-, tri-, and octa-calcium phosphates and their hydrated phases were not found in the XRD patterns. This observation of the presence of hydroxyapatite corroborates results form the thermochemical calculations predicting that hydroxyapatite is the stable calcium-phosphate phase to form under the conditions considered in the following Table 2, which includes the estimates of the ΔG°_{R}(kJ/mol) and ΔHG°_{R}(kJ/mol) for various reactions involving hydroyapatite, chloroapatite, calcite, fluorite and fluoroapatite.

TABLE 2

| | | ΔG°_{R} | ΔH°_{R} |
|---|---|---|---|
| Reaction | | (kJ/mol) | (kJ/mol) |
| Precipitation of HA | 5CaCO₃ + 3H₂PO₄⁻ + | −203.3 | −29.7 |
| | OH⁻ + 4H⁺ ⇄ | | |
| | Ca₅(PO₄)₃OH + 5H₂CO₃ | | |
| Precipitation of CA | 5CaCO₃ + 3H₂PO₄⁻ + | −149.3 | 4.67 |
| | Cl⁻ + 4H⁺ ⇄ | | |
| | Ca₅(PO₄)₃Cl + 5H₂CO₃ | | |
| Dissolution of Calcite | CaCO₃ ⇄ Ca²⁺ + CO₃²⁻ | 47.4 | −12.9 |
| Precipitation of Fluorite | Ca²⁺+ 2F⁻⇄ CaF₂ | −58.2 | −11.5 |
| Conversion of CA to FA | Ca₅(PO₄)₃Cl + F⁻ ⇄ | −78.8 | −60.5 |
| | Ca₅(PO₄)₃F + Cl⁻ | | |
| Conversion of HA to FA | Ca₅(PO₄)₃OH + F⁻ ⇄ | −24.8 | −26.1 |
| | Ca₅(PO₄)₃F + OH⁻ | | |

The FTIR spectra of phosphate-coated calcite/limestone exhibited strong bands in the regions of 1000-1100 cm⁻¹ and 500-600 cm⁻¹, which correspond to the v₃ and v₄ (asymmetric stretching and bending modes, respectively) vibrations of the PO₄³⁻ moiety. The FTIR spectroscopy of solid phosphate phases produced in the presence and absence of 0.01 M NaCl solution (not shown) have identical spectra and align well with the synthetic HA, suggesting that the newly formed phase on calcite/limestone is hydroxyapatite (FIG. 6, B). Although synthetic hydroxyapataite exhibits characteristic OH vibrational modes at 3572 and 635 cm⁻¹, these bands are weak and not well resolved in both fine and coarse grained products. While the FTIR spectra of the fine grain product are well aligned with the standard HA peaks, the spectra taken for the hydroxyapatite coated-coarse limestone exhibit small shifts in energy and are also broader. This could be a result of the presence of CO₃²⁻ or protonated PO₄³⁻ ions in the hydroxyapatite crystals, or adsorbed PO₄³⁻ ions on calcite.

Hydroxyapatite Coverage on Calcite and Limestone.

The surface coverage and crystal morphology of hydroxyapatite coatings evolved with time as the limestone particles were exposed to PO₄³⁻ solutions; such is seen in FIGS. 7 and 8, as well as has been previously discussed with reference to FIGS. 2, 3 4 and 5. FIG. 7 depicts in its four panes or parts “A”,“B”, “C” and “D” representative SEM images of limestone particles (viz., carbonate mineral) showing the progression of surface coverage of hydroxyapatite from 0% in A, 20% in B, 60% in C and to 100% surface coverage in D. The sample shown in A was reacted at pH of 6, at 40° C. without PO₄³⁻ in a 0.01 M NaCl aqueous solution following 7 days. The sample shown in B was reacted at pH of 6, at 40° C. in a 5.26 mM PO₄³⁻ aqueous solution following 2.25 days. The sample in C was reacted at pH of 6, at 40° C. in a 0.01 M NaCl aqueous solution following 21 days. The sample in D was reacted at pH of 6, at 80° C. in a in a 5.26 mM PO₄³⁻ aqueous solution following 7 days. FIG. 8 depicts in its four panes or parts representative SEM images of hydroxyapatite coatings on limestone grains showing the crystal habitats of the hydroxyapatite. In pane “A”, is shown unreacted limestone at a magnification of 3500×. In pane “B” is illustrated a fibrous hydroxyapatite phas at 10,000×. In pane “C” is shown an intermediate hydroxyapatite phase at a magnification of 12,000×. In pane “D” is illustrated a platy hydroxyapatite phase at 10,000×. The sample shown in A was reacted at a pH of 6, 40° C. without PO₄³⁻ in a 0.01 M NaCl aqueous solution following 1 day. The sample shown in B was reacted at a pH of 6, at 40° C. in a 0.52 mM PO₄³⁻ aqueous solution following 2.25 days. The sample shown in C was reacted at a pH of 76, at 60° C. in a 5.26 mM PO₄³⁻ in a 0.01 M NaCl aqueous solution following 7 days. The sample shown in part D is 7 days. The sample shown in part D of FIG. 8 is at 4 days.

SEM images of large calcite crystals reacted with 0.526 and 5.26 mM PO₄³⁻ at 25° C. indicated that hydroxyapatite grows and covers approximately 50% of exposed calcite surfaces in 6 days. Granular limestone also showed the same behavior and the surface coverage did not increase continuously with longer reaction time, suggesting insufficient PO₄³⁻ concentration for further hydroxyapatite precipitation, as is discussed with reference to FIG. 5. Subsequent additions of PO₄³⁻ (5.26 mM) encouraged precipitation of hydroxyapatite and improved the coverage of hydroxyapatite on granular limestone, as represented on FIG. 5. However, complete coverage could not be achieved on all grains even after eight PO₄³⁻ additions during the formation reaction. On average, the granular limestone exhibited 60-90% coverage by hydroxyapatite, as noted on Table 1 and the precipitated hydroxyapatite was found in two different forms: as coatings on limestone surfaces, and also as fine powder (10-20% by vol.). These finer grains of hydroxyapatite were either the result of homogeneous precipitation in solution or dislodging of hydroxyapatite grains from the limestone surface during stirring. Fluoride sorption was conducted for both of these hydroxyapatite phases: hydroxyapatite coated limestone particles as well as hydroxyapatite coated-limestone+fines.

Crystal Morphology of HA Grown on Calcite and Limestone.

The SEM images of unreacted calcite/limestone exhibit smoother surfaces than the PO₄³⁻-reacted limestone as seen from the various parts of FIG. 8, and the morphology of precipitated HA crystals changed with the growth conditions. At shorter reaction times, higher pH, and at lower temperature and PO₄³⁻ concentrations, the initial HA grown on limestone grains displayed fibrous nanoscale interwoven HA crystals, i.e. seen at part B of FIG. 8. As the reaction progressed, crystal size increased to a micron and gradually converted to platy morphology towards the end stages of synthesis, seen at part D of FIG. 8. This platy morphology was observed more commonly with increased reaction times, higher temperatures, higher PO₄³⁻ concentrations, and lower pH. The crystal morphology also remained intact during gentle washing procedures. However, more vigorous washing procedures smoothed the crystal surfaces, which can seen in on FIG. 9, in which parts “A” and “B” respectively depict at magnifications of 3500× and 200× hydroxyapatiate coated limestone particles, of batch 1 (corresponding to E1) at the cited reaction conditions and following 4 days of reaction time, and in parts “C” and “D”, are depicted the hydroxyapatiate coated limestone particles of batch 1 (corresponding to E1) at respective magnifications of 3500× and 150× subsequent to reaction time of 4.25 days and subsequent to washing.

The novel hydroxyapatiate coated limestone particles (Table 1; 4FL+F, 5FL+F) used in detailed fluoride sorption studies exhibited platy crystals in the size range of 200-800 nm (thickness approximately 20 nm).

Based on the foregoing, it was determined that preferred reaction conditions for the formation of the novel filter material which are particularly effective in sorption from water may be synthesized under the following conditions: 80° C. in 5.26 mM PO₄³⁻ solutions adjusted to pH 6 for sufficient time to obtain a desired degree of surface coverage, preferably at least about 25% surface coverage, more preferably at least about 50% surface coverage and especially preferably at least about 75% surface coverage of the carbonate mineral (i.e., limestone, calcite).

Fluoride Reactions with HA-Coated-Limestone.

Fluoride reactions with the synthesized hydroxyapatite-coated-limestone were conducted as a function of F⁻ concentration, reaction time, and particle size. When synthetic hydroxyapatite-coated-limestone was reacted with water prior to F⁻ sorption, the pH increased to about around 8.5 (or about 9.5 for hydroxyapatite-coated-coarse limestone) after the first hour. This increase in pH may have been caused by the dissolution of exposed, unreacted limestone (calcite) surfaces. However, the pH was adjusted to near neutral pH for all sorption studies.

Fluoride Sorption Kinetics on HA-Coated-Limestone.

The rate of F⁻ sorption by hydroxyapatite coated limestone (batch 4FL+F) was examined as a function of initial F⁻ concentration. About 90% of the total F− sorbed by the hydroxyapatite-coated-limestone was taken up in the first 60, 180, and 345 minutes for 0.21 mM, 0.42 mM, and 1.32 mM F⁻ respectively, as is demonstrated on FIG. 10. In that figure, there are depicted the results of three-day kinetic experiments of F− sorption for batch 4FL+F at solid to aqueous solution ratio of 4 grams/liter, with initial F− concentrations of 0.21 mM, 0.42 mM, or 1.32 mM. (corresponding to “diamond”, “triangular” and “square” markers) also depicted on the figure is the recommended World Health Organization limit (horizontal line, at 79 μM of F−). As can be seen from the reported results, the uptake of F− by the hydroxyapatite coated limestone was particularly rapid, with the reduction of the initially concentration of 0.21 and 0.42 mM of F− to be reduced below the mandated World Health Organization limit in less than 1 hour of contact time. The sorption kinetic data were fit using different rate models, and the data fit well with the pseudo-second-order model; see FIG. 11 and the following Table 3 which indicates pseudo-second-order kinetic fit parameters.

TABLE 3
Pseudo-second-order Kinetic Fit Parameters

| | | Solid to | | | |
|---|---|---|---|---|---|
| | Initial | solution | | k | h |
| | F⁻ | ratio | qe | (g mg⁻¹ | (mg g⁻¹ |
| Filter | (mM) | (g L⁻¹) | (mg g⁻¹) | min⁻¹) | min⁻¹) |
| 4FL + | 0.21 | 4 | 1.0 | 0.15 | 0.15 |
| F | 0.42 | 4 | 1.9 | 0.015 | 0.054 |
| | 1.32 | 4 | 4.6 | 0.0057 | 0.12 |
| HA | 4.2 (pH 5) | 10 | 4.7 | 0.0047 | 0.11 |
| | 4.2 (pH 8) | 10 | 7.5 | 0.0049 | 0.28 |

FIG. 11 in its two parts “A” and “B” represent model fits for the F⁻ kinetic experiments at initial concentrations of F⁻ of 0.21 mM (“squares”), 0.42 mM (“diamonds”), and 1.32 mM (“triangles”) of solutions of 4 g/liter of batch 4FL+F, and pure hydroxyapatite at 10 g/liter equilibrated at a pH of 5 (“plus sign”) or pH 8 (“asterisk”) with 4.2 mM of F−. All linear fits had a R² of >0.999. The pseudo-second order rate constants obtained for pure hydroxyapatite (conducted at 4.2 mM of initial F⁻) and HA-coated-limestone (conducted at 1.32-0.2 mM of initial F) in this study were in the range of 0.005-0.15 g mg⁻¹ min⁻¹. It should be noted that the observed small variations in rates were considered to be caused by different initial F⁻ concentration, particle size, and suspension concentrations used.

Magnitude of F⁻ Sorption on Hydroxyapatite-Coated-Limestone.

The amount of F⁻ removed from solution was observed to increase with a decrease in the (individual or average) sizes of the filter particles and increased with a greater initial F⁻ concentration; reference is made to FIGS. 12 and 13. FIG. 12 illustrates fluoride sorption capacity of different synthesis products produced according to the invention while FIG. 13 depicts F⁻ absorption isotherms of different synthesis products produced according to the invention. As visible from one or both of these figures, therefrom, the F⁻ sorption on hydroxyapatite-coated-coarse limestone (batches 1CL and 2CL; solution ratio of 40 g L⁻¹) began to saturate at 0.53 mM of initial aqueous F⁻ (4 mmol F⁻ kg⁻¹ of solid; Figure S9), and the sorption was similar for the product prepared in the presence (batch 1 CL) and absence of Cl (batch 2CL). When fines were added to the corresponding coarse synthesis product (1CL+F and 3CL+F), F⁻ sorption improved and began to saturate at 1.05 mM initial aqueous F⁻ (14.5 mmol F⁻ kg⁻¹ of solid for 3CL+F). The hydroxyapatite-coated-fine limestone (4FL+F, 5FL+F) exhibited high sorption capacities, reaching a plateau around 465 mmol F kg⁻¹ in a 4 g L⁻¹ suspension; c.f. FIG. 13, part B. The HA fraction in 4FL+F and 5FL+F was approximately 28% by weight. When compared, micron-sized pure hydroxyapatite showed less F⁻ uptake than the filter materials according to the invention; c.f. FIG. 13, part B. This increased sorption ability of the finer fraction is a result of increased surface area and increased amount of hydroxyapatite available on a per gram basis. It was also observed that increases in the solid to solution ratio also improved F⁻ sorption, c.f. FIG. 13B and FIG. 12B. After the plateau around 465 mmol F⁻ kg⁻¹ for this finer fraction, more F⁻ was sorbed, which was hypothesized to be likely due to a different mechanism.

Mechanisms of F⁻ Uptake.

Fluoride reactions with hydroxyapatite was observed to result in adsorption, ion-exchange with OH groups in hydroxyapatite and formation of fluoridated-hydroxyapatite (Ca₅(PO₄)₃(OH,F)) or fluorapatite (Ca₅(PO₄)₃(F)), and precipitation of fluorite (CaF₂). While all these different mechanisms can occur simultaneously at high aqueous F⁻ concentration, precipitation of fluoroapatite or fluorite may not occur until the reacting solutions reach saturation with respect to these phases.

Sorption isotherms obtained for different batches of hydroxyapatite-coated-limestone particles indicated a sorption maximum above 0.5 mM of equilibrium F⁻ concentration with higher solid phase F⁻ concentrations for finer hydroxyapatite-coated-limestone and for larger suspension concentrations; see FIG. 13. However, the sorption studies conducted up to high F⁻ concentrations (initial F⁻ concentration: 10.5 mM, suspension concentration: 4 g L⁻¹) suggested that the magnitude of sorption increased steeply up to 0.1 mM, gently increased between 0.1 and 1.5 mM, and increased again with a steeper slope above 1.5 mM of equilibrium F⁻ concentration. This suggested a change in the sorption mechanisms, which were tentatively identified as adsorption and ion-exchange with structural OH⁻ below 0.1 mM, and saturation of surface sites and conversion of hydroxyapatite to fluroapatite up to 1.5 mM, and precipitation of fluorite above 1.5 mM. Although molecular mechanisms of F sorption could not be gleaned directly from the sorption isotherms, thermodynamic speciation calculations can provide clues to possible reaction mechanisms. Thermodynamic speciation conducted using equilibrium F⁻, Ca²⁺, PO₄³⁻, and H⁺ concentrations indicate that fluoroapatite is saturated for most solutions, and fluorite is saturated for only highly concentrated F⁻ solutions. Although fluorite was saturated with respect to the starting F⁻ concentration, this phase is expected to be below saturation for equilibrium F⁻ concentrations, especially for lower initial F⁻ levels. This indicates that even if fluorite precipitates initially, it is unstable in final reacting solutions and should convert to fluoroapatite or fluoridated-hydroxyapatite.

In addition, F-XANES spectroscopy studies were conducted on F⁻ reacted-hydroxyapatite to assist in predicting reaction mechanisms. However, these XANES spectroscopy studies were limited to samples prepared at high concentrations in order to obtain an X-ray signal. The results of the F-XANES spectroscopy measurements are also in agreement with these electron spectroscopy observations. The F-XANES spectrum of crystalline fluorite exhibits a distinct doublet in the energy range of 689-693 eV, and this doublet corresponds to the 1s electronic transitions to 4a₁ and 2b₂ orbitals of F⁻, while the features above 695 eV correspond to the scattering by nearby Ca atoms; reference is made to FIG. 14. In that Figure, parts “A” and “B” depict over different energy regions, fluorine K-edge XANES spectra of (a) fluorite CaF₂ and hydroxyapatite exposed at various pH and F⁻ concentrations including: (b) 53 nM F⁻ at pH 5.5, (c) 53 mM F⁻ at pH 8.0, (d) 11 mnM F⁻ at pH 5.5, (e) 11 mnM F⁻ at pH 8.0 and (f) 5.3 mM F⁻ at pH 5.5. The spectra were aligned were calibrated with the maximum intensity of the first peak of CaF² at 689.7 eV. When compared to this fluorite standard, synthetic hydroxyapatite exposed to 53 mM F⁻ showed spectral features similar to that of fluorite. The XANES peaks for this sample were broader than the fluorite standard, and this may have arisen from differences in fluorite crystallinity. The hydroxyapatite reacted with dilute F⁻ concentrations (initial F⁻ concentration of 5.3, 11 mM) and at pHs of 5.5 and 8.0 exhibited the doublet in the energy range of 689-693 eV, similar to fluorite; however, the scatter peak, characteristic of fluorite, at 697 eV was absent in these samples, c.f. FIG. 14, part B. This suggested that fluorite is not the primary reacting phase, and points to the formation of fluoridated-hydroxyapatite or fluoroapatite at F− concentrations below 11 mM.

As can be seen from the foregoing, as demonstrated, the novel ydroxyapatite-coated limestone filter materials of the invention provided excellent takeup of F⁻ from aqueous compositions, in a particularly rapid manner.

1. Hydroxyapatite-coated carbonate mineral particulate filter materials effective in removing fluoride ions from drinking water sources or wastewater, wherein the hydroxyapatite coating are one or more crystalline forms of hydroxyapatite present on the surface of the carbonate mineral particles.

2. Hydroxyapatite-coated carbonate mineral particulate filter materials according to claim 1, are micron or submicron sized.

3. Hydroxyapatite-coated carbonate mineral particulate filter materials according to claim 2, which have an overall dimension 0.1 to about 1000 microns (μm).

4. Hydroxyapatite-coated carbonate mineral particulate filter materials according to claim 3, which are about 40 to about 300 microns in their largest dimension.

5. Hydroxyapatite-coated carbonate mineral particulate filter materials according to claim 1, wherein at least about 25% of the surface of the particles are coated with crystalline nano-particles of hydroxyapatite.

6. Hydroxyapatite-coated carbonate mineral particulate filter materials according to claim 5, wherein between about 50%-100% of the surface of the particles are coated with crystalline nano-particles of hydroxyapatite.

7. Hydroxyapatite-coated carbonate mineral particulate filter materials according to claim 1, wherein the filter materials have an overall dimension 40 to about 300 microns (μm) in their largest dimension.

8. A filter medium or filter assembly which comprises a quantity of the hydroxyapatite-coated carbonate mineral particulate filter materials according to claim 1.

9. A filter medium or filter assembly which comprises a quantity of the hydroxyapatite-coated carbonate mineral particulate filter materials according to claim 6.

10. A filter medium or filter assembly which comprises a quantity of the hydroxyapatite-coated carbonate mineral particulate filter materials according to claim 7.

10. A process for the synthesis of hydroxyapatite-coated carbonate mineral particulate filter materials which comprises the steps of:
reacting in a liquid medium, granular carbonate minerals with a phosphate to thereby form hydroxyapatite on the surface of the carbonate material.

11. The process according to claim 10, wherein the resulting filter material has crystalline nanoparticles of hydroxyapatite covering at least about 25% of the surface of the carbonate mineral upon which they are present.

12. The process according to claim 10, wherein the resulting filter material has crystalline nanoparticles of hydroxyapatite covering about 50%-100% of the surface of the carbonate mineral upon which they are present.

13. The process according to claim 10, wherein the amount of phosphate present in the liquid medium during the reaction is between about 0.01 mM to about 250 mM per liter of the liquid medium.

14. The process according to claim 13, wherein the amount of phosphate present in the liquid medium during the reaction is between about 1 mM to about 25 mM per liter of the liquid medium.

15. The process according to claim 10, wherein the pH in the liquid medium during the reaction is between about 3 and about 11.

16. The process according to claim 10, wherein the temperature of the liquid medium during the reaction is between about 15° C. and about 95° C.

17. The process according to claim 16, wherein the temperature of the liquid medium during the reaction is between about 75° C. and about 90° C.

18. The process according to claim 10, wherein the total amount of the phosphate used in the reaction is added at one time to the liquid medium.

19. The process according to claim 10, wherein the total amount of the phosphate used in the reaction is added in separate aliquots at several different times during the reaction.

20. A water treatment method, wherein contaminated water containing fluoride is known to be present or is suspected, is contacted with the hydroxyapatite-coated carbonate mineral particulate filter materials according to claim 1, and thereby the concentration of fluoride in the treated contaminated water is reduced.
